(19) United States
(12) Patent Application Publication
(10) Pub. No.: US 2015/0019962 A1
(43) Pub. Date: Jan. 15, 2015

(54) METHOD AND APPARATUS FOR PROVIDING ELECTRONIC DOCUMENT

(71) Applicant: Samsung Electronics Co., Ltd., Gyeonggi-do (KR)

(72) Inventor: Seungnyun KIM, Incheon (KR)

(21) Appl. No.: 14/332,032

(22) Filed: Jul. 15, 2014

(30) Foreign Application Priority Data
Jul. 15, 2013 (KR) 10-2013-0082790

(51) Int. Cl. G06F 17/21; G06F 3/0484; G06F 3/0483

(52) U.S. Cl. CPC G06F 17/211; G06F 3/0483; G06F 3/04842
USPC 715/277

(57) ABSTRACT

Disclosed are a method and an apparatus for providing an electronic document. The method includes displaying at least one part of the electronic document, selecting a section from text included in the currently-displayed part of the electronic document, determining at least one related part of the electronic document, where the at least one related part is a part of the electronic document which is related to the selected section, and displaying the at least one related part.

### PRIORITY

This application claims priority under 35 U.S.C. §119(a) to Korean Patent Application No. 10-2013-0082790, filed on Jul. 15, 2013 in the Korean Intellectual Property Office, which is incorporated herein by reference.

### BACKGROUND OF THE INVENTION

1. Field of the Invention

The present invention relates generally to a method and an apparatus for providing an electronic document, and more particularly, to a technology in which a display unit of a terminal provides content of a form similar to that of an actual paper document.

2. Description of the Related Art

Recently, a technology has been developed which provides various forms of content through a multimedia terminal. Particularly, an electronic book (e-book) which provides, as multimedia content, a document in the form of a printed book is becoming common.

The e-book refers to a digital book which enables information, such as text, an image, and the like, to be recorded on an electronic medium and used. A recent e-book-related technology focuses on a technology which enables a user to have the same experience as if the user were reading a printed book.

For example, a technology which provides the same effect as a reader turning over the pages of an actual book when the user moves to the next page of the e-book, a technology which provides a bookmark function, or the like is being proposed. Also, a technology is being used which increases readability by displaying the e-book page by page depending on the size of a display of a terminal.

However, a technology has not yet been provided which can improve the convenience of the user by utilizing characteristics of an e-book to freely change a configuration of pages to be displayed.

### SUMMARY

The present invention has been made to address at least the problems and disadvantages described above and to provide at least the advantages described below. Accordingly, an aspect of the present invention is to provide information of a part related to a currently-displayed part of an electronic document so as to improve the convenience of a user who uses the electronic document.

In accordance with an aspect of the present invention, a method for providing an electronic document is provided. The method includes displaying at least one part of the electronic document, selecting a section from text included in the currently-displayed part of the electronic document, determining at least one related part of the electronic document, where the at least one related part is a part of the electronic document which is related to the selected section, and displaying the at least one related part.

In accordance with another aspect of the present invention, a terminal is provided. The terminal includes a display unit configured to display at least one part of the electronic document, and a control unit configured to perform a control operation for selecting a section from text included in the currently-displayed part of the electronic document, determining at least one related part of the electronic document, where the at least one related part is a part of the electronic document which is related to the selected section, and displaying the at least one related part.

### BRIEF DESCRIPTION OF THE DRAWINGS

The above and other aspects, features and advantages of the present invention will be more apparent from the following detailed description in conjunction with the accompanying drawings, in which:

FIG. 1 is a block diagram illustrating an internal configuration of a terminal, according to an embodiment of the present invention;

FIG. 2 is a flowchart illustrating a process for providing an electronic book, according to an embodiment of the present invention;

FIG. 3 is a view illustrating an example of a menu which provides references to a related page, according to an embodiment of the present invention;

FIG. 4 is a screen view illustrating an example in which a user selects a character string, according to an embodiment of the present invention;

FIGS. 5A and 5B are screen views illustrating an example of automatically selecting a character string and displaying a menu, according to an embodiment of the present invention;

FIG. 6 is a screen view illustrating an example of simultaneously displaying a current page and a related page, according to an embodiment of the present invention;

FIG. 7 is a screen view illustrating another example of simultaneously displaying a current page and a related page, according to an embodiment of the present invention; and

FIG. 8 is a screen view illustrating still another example of simultaneously displaying a current page and a related page, according to an embodiment of the present invention.

### DETAILED DESCRIPTION OF EMBODIMENTS OF THE PRESENT INVENTION

Hereinafter, embodiments of the present invention will be described in detail with reference to the accompanying drawings. It should be noted that the same elements will be designated by the same reference numerals although they are shown in different drawings. Further, detailed descriptions related to well-known functions or configurations capable of making the subject matter of the present invention unnecessarily obscure will be omitted.

Also, portable terminals, such as an e-book reader, which provides an e-book through a display unit, a tablet Personal Computer (PC), a smart phone, and the like, are used in describing embodiments of the present invention. However, the present invention is not limited to the e-book, but can be applied even to other types of terminals, in which electronic document providing technologies or technologies similar to electronic document providing technologies are implemented, with slight modification without departing from the scope of the present invention. Those skilled in the technical field of the present invention will be able to determine this applicability of the main subject matter of the present invention.

The method and the apparatus for providing an electronic document, according to embodiments of the present invention, provide information of a part related to a currently-displayed part of the electronic document by utilizing the characteristics of the electronic document to freely change a configuration of pages to be displayed, thereby improving the convenience of the user.

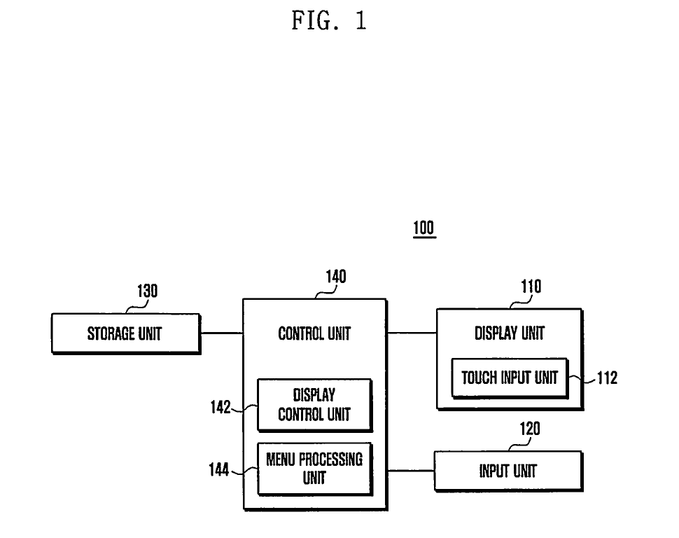

FIG. 1 is a block diagram illustrating an internal configuration of a terminal, according to an embodiment of the present invention.

Referring to FIG. 1, the terminal 100, according to an embodiment of the present invention, includes a display unit 110, an input unit 120, a storage unit 130, and a control unit 140. When the terminal 100 provides an e-book through a touch-type display, the display unit 110 may additionally include a touch input unit 112. Also, according to an embodiment of the present invention, the control unit 140 may include a display control unit 142 and a menu processing unit 144 in order to provide the e-book.

The display unit 110 is a device for visually providing the e-book, according to an embodiment of the present invention, and displays a part matched to a unit of display of an electronic document or displays at least one page of the e-book, according to a setting. Also, the display unit 110 may visually provide a user with a menu of the terminal 100, input data thereof, function setting information thereof, and various other pieces of information.

The display unit 110 may be implemented by a Liquid Crystal Display (LCD), an Organic Light Emitting Diode (OLED) display, an Active Matrix Organic Light Emitting Diode (AMOLED) display, a flexible display, a three-dimensional (3D) display, and the like.

Meanwhile, when the display unit 110 is implemented by a touch-type display, the display unit 110 may further include the touch input unit 112. The touch input unit 112 converts pressure applied to a particular part of the display unit 110, or a change in capacitance or the like, which is generated at a particular part of the display unit 110, into an electrical input signal. The touch input unit 112 detects the pressure during a touch, as well as the touched position and area.

Specifically, the touch input unit 112 senses a touch input of the user, generates a sensing signal, and delivers the generated sensing signal to the control unit 140. The sensing signal includes coordinate information on coordinates touched by the user. When the user performs a drag gesture in a touched state, the touch input unit 112 generates a sensing signal including coordinate information of a movement path, and delivers the generated sensing signal to the control unit 140.

The touch input unit 112 may be implemented by a touch sensor, for example, in a capacitive overlay type, a resistive overlay type, a surface acoustic wave type, or an infrared beam type. Alternatively, the touch input unit 112 may be implemented by a pressure sensor. In addition to above-described sensors, other types of sensor devices capable of sensing the contact or pressure of an object may be used to implement the touch input unit 112.

The input unit 120 receives, as input, manipulation by the user for controlling the terminal 100, generates an input signal, and delivers the generated input signal to the control unit 140. The input unit 120 may be implemented by a keypad including numeric keys, arrow keys and the like, or by a mouse device. When the terminal 100 is a portable device, a predetermined number of function keys may be formed as one body with the display unit 110. Further, when the display unit 110 is implemented by a touch-type display, the number of function keys of the input unit 120 may be reduced, or the function keys thereof may be omitted.

The storage unit 130 serves to store programs and data necessary for an operation of the terminal 100. The storage unit 130 is divided into a program area and a data area. The storage unit 130 may store, in the program area, a program for controlling an overall operation of the terminal 100, an Operating System (OS) booting the terminal 100, application programs necessary for the reproduction of multimedia content and the like, and application programs necessary for other optional functions of the terminal 100, such as a voice call function, a camera function, a sound reproduction function, an image or moving image reproduction function, and the like. The data area is an area in which data generated according to use of the terminal 100 is stored. Images, moving images, phone books, audio data, and the like may be stored in the data area.

According to an embodiment of the present invention, the storage unit 130 stores data of an e-book to be provided by the display unit 110, and stores, in a unit of pages, content information included in each page of the e-book. Also, the storage unit 130 stores setting information of a phrase to be selected from a page, information on a menu display method, and the like, as information that the control unit 140 needs in order to construct a menu.

The control unit 140 controls overall operations of elements of the terminal 100. According to an embodiment of the present invention, the control unit 140 may include the display control unit 142 and the menu processing unit 144.

The display control unit 142 controls the display unit 110 to display at least one page of an e-book. Also, when the menu processing unit 144 generates a menu matched to a currently-displayed page, the display control unit 142 controls the display unit 110 to display the relevant menu.

The menu processing unit 144 selects a character string for constructing a menu, from a page currently displayed by the display unit 110, determines a related page matched to the selected character string based on data stored in the storage unit 130, and generates the menu. For example, the related page may be a page in which a detailed explanation of the extracted character string is written. Alternatively, when the selected character string is a question, the related page may be a page in which a correct answer to the relevant question is written. Also, the menu may include a pair of the character strings selected from the page and a number of a related page matched to the selected character string.

Hereinafter, a method for providing an electronic document, according to an embodiment of the present invention, will be described in detail.

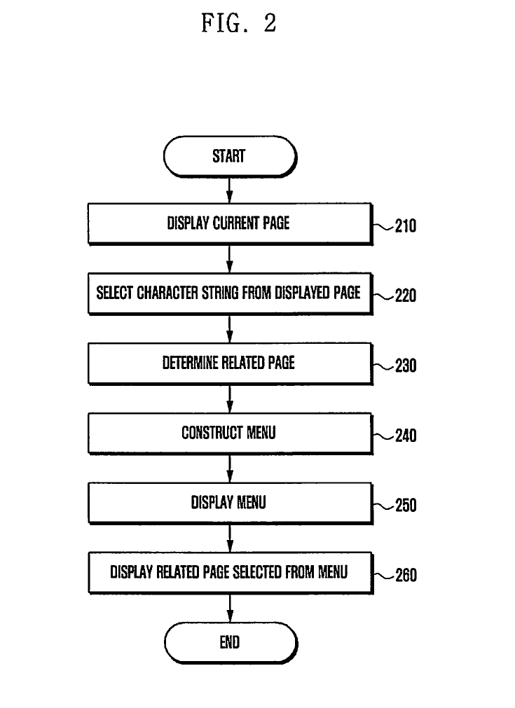

FIG. 2 is a flowchart illustrating a process for providing an electronic book, according to an embodiment of the present invention.

Referring to FIG. 2, according to an embodiment of the present invention, a method for providing an e-book as one form of an electronic document in a unit of pages is illustrated. However, various embodiments of the present invention provide the electronic document in another predetermined unit of display, and can be applied to all forms of technologies which provide information related to a currently-displayed part of the electronic document.

As shown in FIG. 2, in operation 210, a current page which is a part of the e-book is displayed by the display unit 110 of the terminal 100. According to the setting of the display unit 110, the current page corresponds to one page or multiple pages, as a unit of display of the e-book.

In operation 220, the control unit 140 selects a part from text included in the displayed page, as a character string for constructing a menu. A character string may be selected according to an input by the user or according to preset criteria.

For example, the user may select a character string that the user intends to receive information on a related page of the e-book, which is output by the display unit 110. When the display unit 110 is implemented in the form of a touch-type display, a character string may be selected by using a touch-and-drag gesture to the displayed text.

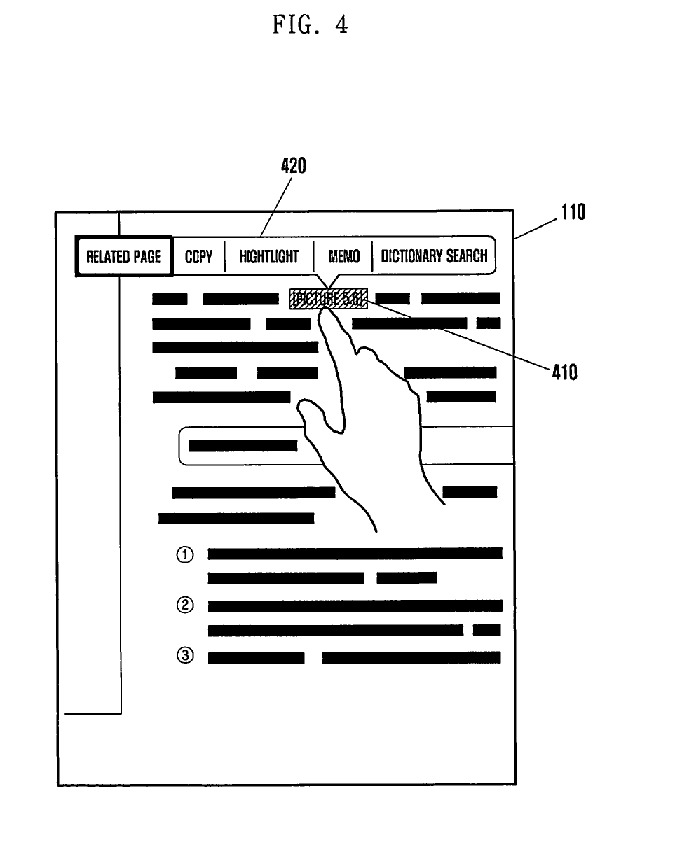

FIG. 4 is a screen view illustrating an example in which a user selects a character string, according to an embodiment of the present invention.

Referring to FIG. 4, a particular page of the e-book is displayed by the display unit 110. When the display unit 110 is implemented by a touch-type display, the user may select a particular character string 410 from text included in the displayed page. In FIG. 4, “picture 5.6” is selected.

When the user has selected the particular character string 410, as illustrated in FIG. 4, the control unit 140 displays a menu 420 including actions capable of being performed based on the selected character string 410. When a menu item named “related page” is selected from the displayed menu 420, the control unit 140 generates a menu indicating a page which is related to the selected character string, and displays the generated menu.

Also, instead of receiving an input corresponding to the selection of a character string from the user, the control unit 140 may analyze text included in the currently-displayed page, and may automatically select a character string for constructing a menu. A reference character string for selecting a character string may be previously set, and the control unit 140 may select a character string coinciding with the reference character string from text included in the currently-displayed page. Examples of the reference character string may include “picture,” “table,” “question,” and “correct answer,” or a particular place, a particular event, the name of a particular person, and the like.

Referring back to FIG. 2, after the character string for constructing the menu is selected from the currently-displayed page, in operation 230, the control unit 140 determines a related part of the e-book, which matches with the selected character string. The related part may be a page related to the selected character string.

For example, when the selected character string is “picture” or “table,” the related page may be a page in which the relevant picture or table is actually displayed. Also, when the selected character string is “question” or “correct answer,” the related page may be a page in which a correct answer of the relevant question is displayed. When the selected character string is a particular place, a particular event, or the name of a particular person, the related page may be a page in which a detailed explanation of the relevant place, event, or person is written.

Additionally, when the selected character string is a particular place, a particular event, or the name of a particular person, the related page may change depending on the currently-displayed page. For example, in the case of a novel, an explanation related to each place, character, event and the like may change depending on the development of the contents of the novel. Accordingly, the related page matched to the character string selected from the currently-displayed page may be determined as a page including the most recent contents related to the relevant character string.

Further, the related page may be a page that the user directly sets in response to the selected character string. For example, the user may previously store a particular character string and a corresponding related page after the user pairs the particular character string with the corresponding related page while reading an e-book once. The pair of the particular character string and the corresponding related page that the user has set may be stored in the storage unit 130. Thereafter, when the user selects the previously-designated character string while reading the e-book again, the control unit 140 searches the storage unit 130 for the related page pre-stored in response to the selected character string.

As described above, according to an embodiment of the present invention, a useful feature is provided to display to a user a related page, when a currently-displayed page of an e-book is different from a page related to a character string selected from the currently-displayed page. Specifically, when the user desires to see a page in an e-book in which specific contents related to a particular character string included in a current page are written, unlike with a book in printed form, which requires the user to manually find a related page, in an embodiment of the present invention, a search may be automatically made for a related page by using characteristics of the e-book, and the related page may be provided to the user.

In operation 240, the control unit 140 constructs a menu based on the character string selected from the currently-displayed page and information on the corresponding related page.

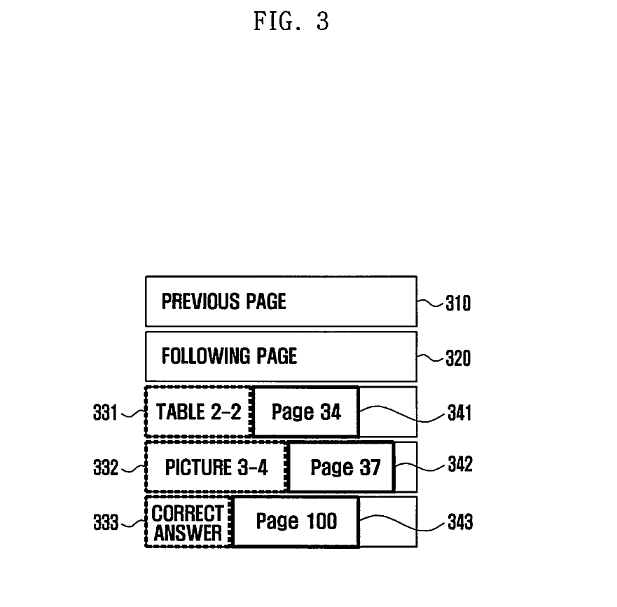

FIG. 3 is a view illustrating an example of a menu which provides information on a related page, according to an embodiment of the present invention.

Referring to FIG. 3, the menu includes a reference to a previous page 310 and a following page 320. The previous page 310 and the following page 320 are related to the currently-displayed page, and represent, respectively, the page immediately preceding and the page immediately following the currently-displayed page. The menu also includes one or more pairs of a character string and a number of a corresponding related page.

Specifically, the menu may include, as items thereof, “table” 331, “picture” 332 and “correct answer” 333 which are character strings selected from a currently-displayed page, and references to related pages 341, 342 and 343, respectively matched to “table” 331, “picture” 332 and “correct answer” 333.

Referring back to FIG. 2, in operation 250, the control unit 140 displays the generated menu through the display unit 110. The menu may be immediately displayed without a separate command, when the generation of the menu matched to the currently-displayed page is completed. Alternatively, the menu may be displayed in response to a particular input.

For example, when the user selects an item named “related page” from the menu 420 displayed after the user selects the character string from the currently-displayed page, as illustrated in FIG. 4, a menu display command is generated, and the generated menu display command is delivered to the control unit 140. The control unit 140 generates a menu and displays the generated menu, according to the menu display command. A display position of the menu may change according to a setting, and the menu may be displayed adjacent to the character string selected by the user.

In another embodiment of the present invention, when a character string is not selected by the user, but is selected by the control unit 140, a command for displaying a menu may be input in another form.

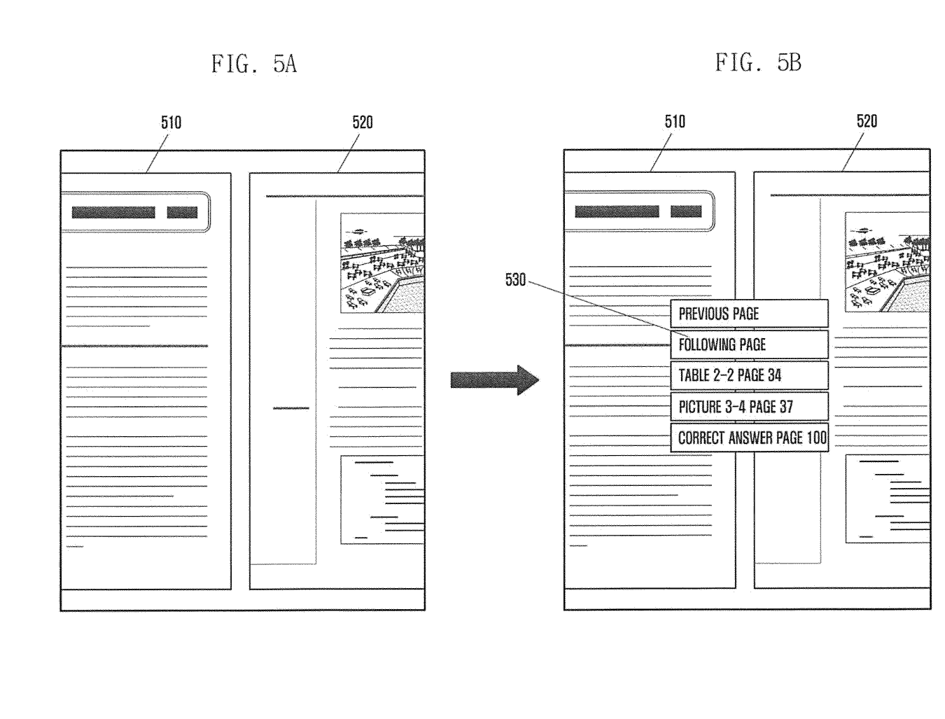

FIGS. 5A and 5B are screen views illustrating an example of automatically selecting a character string and displaying a menu, according to an embodiment of the present invention.

Referring to FIGS. 5A and 5B, when an e-book is displayed by the display unit 110, a current page is switched to another page in a slide scheme. Accordingly, in the process of switching from a current page to another page in the slide scheme, a part 510 of a current page and a part 520 of a next page may be simultaneously displayed as illustrated in FIG. 5A. Alternatively, a part 500 of a previous page (not shown) and a part 510 of a current page may be simultaneously displayed.

When a screen is stopped in a state of simultaneously displaying the two pages 510 and 520 as illustrated in FIG. 5A, namely, when a page slide operation is stopped for a predetermined time period or more, the control unit 140 senses the stop of the page slide operation, performs the selection of a character string from the current page and the generation of a menu, and displays the generated menu. Referring to FIG. 5B, as the page slide operation is stopped, a menu 530 is displayed between the two pages 510 and 520.

Referring back to FIG. 2, in operation 260, when a command for selecting one of the menu items of menu 530 is received as input from the user, the control unit 140 displays a related page matched to the command.

As an example of displaying a related page, the control unit 140 may change the display of the screen, from the currently-displayed page to the selected related page. Alternatively, the control unit 140 may divide the screen of the display unit 110, and may simultaneously display the current page and the related page.

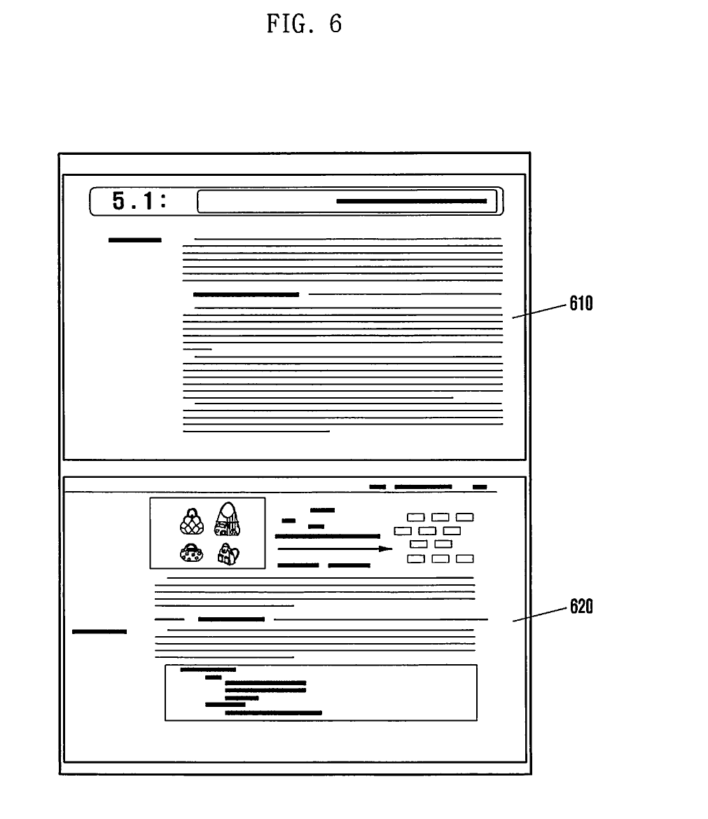

FIG. 6 is a screen view illustrating an example of simultaneously displaying a current page and a related page, according to an embodiment of the present invention.

Referring to FIG. 6, a menu is generated from a current page 610 and is displayed. When one item is selected from the menu, a related page 620 matched to the selected item is displayed simultaneously with the current page 610. The placement of the current page 610 and the related page 620 may change according to a setting.

For example, when there are two or more related pages matched to one character string, the screen of the display unit 110 is not divided into two parts but is divided into three or more parts, and all related pages are simultaneously displayed. Alternatively, all related pages corresponding to each item of the menu can be displayed on one screen simultaneously.

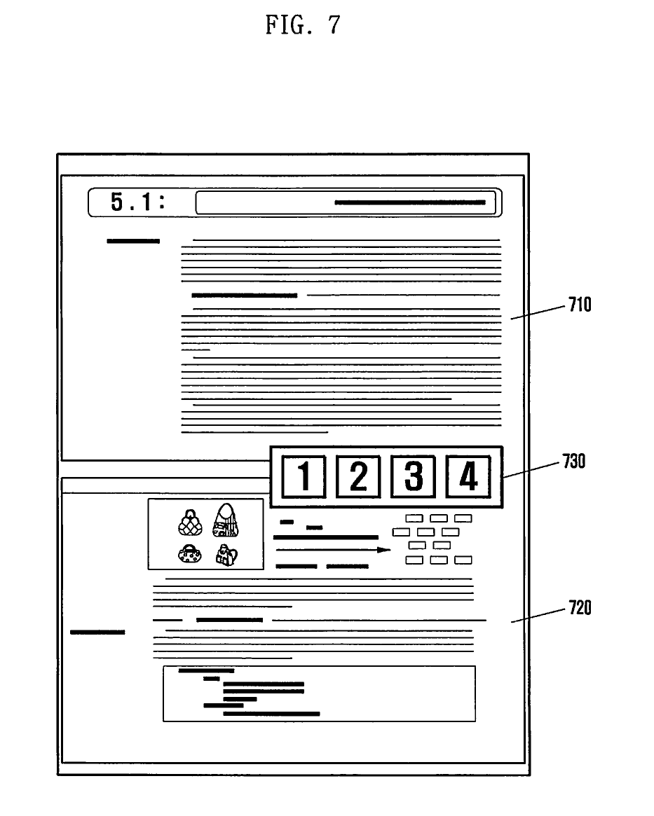

FIG. 7 is a screen view illustrating another example of simultaneously displaying a current page and a related page, according to an embodiment of the present invention.

Referring to FIG. 7, a menu is generated from a current page 710 and is displayed. When one item is selected from the menu, one related page 720 matched to the selected item may be displayed simultaneously with the current page 710.

When there are multiple related pages matched to one character string or when information on related pages included in the menu is intended to be provided together, the control unit 140 displays on the screen, an icon 730 indicating the number of related pages, and thereby enables the user to conveniently change to another related page.

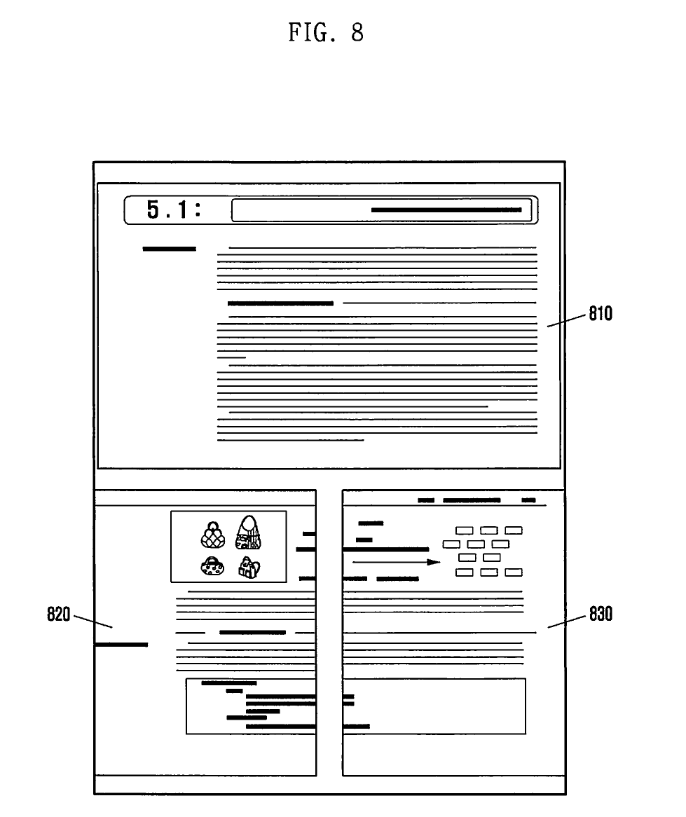

FIG. 8 is a screen view illustrating still another example of simultaneously displaying a current page and a related page, according to an embodiment of the present invention.

Referring to FIG. 8, a menu is generated from a current page 810 and is displayed. When one item is selected from the menu, related pages 820 and 830 matched to the selected item may be displayed simultaneously with the current page 810.

As illustrated in FIG. 8, when there are multiple related pages matched to one character string or when information on related pages included in the menu is intended to be provided together, the multiple related pages 820 and 830 may be displayed so as to switch from a current page to another page in a slide scheme. Accordingly, the user can conveniently view pages related to the current page on one screen.

Those skilled in the art can appreciate that it is possible to implement the present invention in another specific form without changing the technical idea or the indispensable characteristics of the present invention. Therefore, it should be understood that the above-described embodiments are illustrative and are not limiting under any interpretation of the present invention. The scope of the present invention is defined by the appended claims to be described below, rather than the detailed description. Accordingly, it should be appreciated that all modifications or variations derived from the meaning and scope of the appended claims and their equivalents are included in the range of the present invention.

Although embodiments of the present invention have been shown and described in this specification and the drawings, they are used in a general sense in order to easily explain the technical contents of the present invention, and to help in the comprehension of the present invention, and are not intended to limit the scope of the present invention. It will be obvious to those skilled in the art to which the present invention pertains that other modified embodiments on the basis of the spirit of the present invention, besides the embodiments disclosed herein, can be carried out.

What is claimed is:

1. A method for providing an electronic document, the method comprising:
displaying at least one part of the electronic document;
selecting a section from text included in the currently-displayed part of the electronic document;
determining at least one related part of the electronic document, wherein the at least one related part is a part of the electronic document which is related to the selected section; and
displaying the at least one related part.

2. The method of claim 1, wherein the selected section is selected according to the user input.

3. The method of claim 1, wherein the selected section corresponds to a phrase satisfying a preset criterion.

4. The method of claim 1, further comprising displaying a menu on the currently-displayed part of the electronic document, when a slide operation is stopped for a preset time period.

5. The method of claim 4, wherein the menu includes at least one of a reference to a previous page, a reference to a following page, and at least one reference to a related part.

6. The method of claim 5, further comprising displaying a related part of the electronic document selected from the menu.

7. The method of claim 6, wherein displaying the related part of the electronic document selected from the menu comprises simultaneously displaying the currently-displayed part and the selected related part by dividing a screen of a display unit.

8. The method of claim 7, further comprising, when the selected related part includes multiple parts of the electronic document, displaying the multiple parts of the electronic document in a slide scheme.

9. A terminal comprising:
a display unit configured to display at least one part of the electronic document; and
a control unit configured to perform a control operation for
selecting a section from text included in the currently-displayed part of the electronic document,
determining at least one related part of the electronic document, wherein the at least one related part is a part of the electronic document which is related to the selected section, and
displaying the at least one related part.

10. The terminal of claim 9, wherein the selected section is selected according to the user input.

11. The terminal of claim 9, wherein the selected section corresponds to a phrase satisfying a preset criterion.

12. The terminal of claim 9, wherein the control unit is further configured to display a menu on the currently-displayed part of the electronic document, when a slide operation is stopped for a preset time.

13. The terminal of claim 12, wherein the menu includes at least one of a reference to a previous page, a reference to a following page, and at least one reference to a related part.

14. The terminal of claim 9, wherein the control unit is further configured to display a related part of the electronic document selected from the menu.

15. The terminal of claim 14, wherein the control unit is configured to simultaneously display the currently-displayed part and the selected related part by dividing a screen of a display unit.

16. The terminal of claim 15, wherein the control unit is further configured, when the selected related part includes multiple parts of the electronic document, to display the multiple parts of the electronic document in a slide scheme.
